(19) United States
(12) Patent Application Publication
(10) Pub. No.: US 2007/0282904 A1
(43) Pub. Date: Dec. 6, 2007

(54) Online referral system and method of use

(76) Inventor: Kreig Mitchell, Boulder, CO (US)

Correspondence Address: LEYENDECKER LEMIRE & DALEY, LLC, C/O PORTFOLIO IP, P.O. BOX 52050, MINNEAPOLIS, MN, 55402, US

(21) Appl. No.: 11/446,927

(22) Filed: Jun. 5, 2006

(51) Int. Cl. G06F 17/00

(52) U.S. Cl. 707/104.1

(57) ABSTRACT

Embodiments comprise a referral service for providing referrals between similar professionals, such as attorneys. In one embodiment, only professionals in a predetermined profession are allowed to become members of the service. Members provide referral listings concerning prospective clients that are posted by the system and can only be viewed by other members. In one variation, the listings are auctioned by the listing member to other qualified members wherein the auction medium is non-monetary credits.

### FIELD OF THE INVENTION

The present invention pertains generally to online referral services.

### BACKGROUND

One of the greatest difficulties for attorneys and other professionals (such as medical doctors and accountants) in establishing their practice is obtaining a client base or client network capable of providing them with a sufficient level of work on a regular basis. The problem is especially acute with attorneys as ethics regulations promulgated by the bars of each of the states limit an attorney's ability to advertise and solicit potential clients.

Historically, attorneys have relied upon networking with clients, other professionals and other attorneys to generate referrals. Often, the most successful lawyers are those that are not necessarily the best at their craft but those that are best at networking or developing relationships. These rainmakers are often also among the oldest attorneys at a firm.

The younger attorneys are fed work from the rainmakers and told that to make partner they must develop their own client base. Unfortunately, the workload at many firms leaves the younger attorney with limited or no time to partake in networking and development activities. Accordingly, many attorneys, especially those that are not particularly adept at client development never advance to partner.

To help lawyers, especially those that are solo practitioners or with a small firm acquire new clients, a number of lawyer listing sites have appeared in the past 10 years or so. Typically these sites provide regional listings of attorneys in particular categories of practice; whereas, others a few claim to screen the attorneys listed on their sites. Some examples include Findlaw.com and Lawyers.com. These types of sites are most often no more than online directories analogous to the Yellow Pages. Since the information concerning the listed attorneys are usually available to anyone with internet access, an attorney receiving an inquiry from someone must spend his/her valuable time or an administrative assistant's time screening the person to determine whether or not the inquirer is serious about hiring an attorney or just fishing for free advice.

There are other online sites wherein a person looking for legal representation provides a description of the representation he/she requires and solicits inquiries from attorneys. Some of these sites may require the attorney to provide a quote concerning how much he/she will charge to perform the legal work. Usually, the attorney will only have limited information about the prospective client to judge whether or not to provide a proposal. Furthermore, the nature of the process tends to attract clients who are shopping for legal services primarily on price rather than quality, and many attorneys, especially the better ones, cannot reasonably provide the solicited legal services for as low a price as would be required to “win” the client.

A third type of internet service attempts to move the decision making authority back into the hands of the attorney. In this service, such as the one offered by LegalMatch.com, the prospective client provides a significant amount of information about the legal representation he/she is seeking as well as a significant amount of personal information, such as his/her occupation and salary. The information is then sent anonymously to attorneys within the same geographic area as the prospective client. They review the information and those that express an interest in the case provide a response to the prospective client. The interested attorneys are revealed to the client and he decides which one he/she would like to hire.

There are numerous problem/issues with this third type of service. For one, the type of clients that have the time and proclivity to fill out the questionnaire and participate in the internet service, don't tend to be the type of clients that need immediate representation. In other words, the client is less likely to actually move forward with the legal representation than a prospective client who has an immediate need for representation. It can be described as a truism that prospective clients that call an attorney are more likely to actually become clients than those who test the waters through other less direct means of communication, such as via letter, email or an online service. Secondly, this type of service still tends to favor the attorney that is a low cost provider and responds to the prospective client's inquiry with a low price. Attorneys that are forthright about the costs to perform the representation in a manner that is most beneficial to the client are very unlikely to receive the work using this type of service. Perhaps one of the most significant issues is that your chance of actually receiving the work depends on the number of attorneys to whom the inquiry was sent. In other words, in most cases, all other things being equal, you will have less than a 50% chance of actually getting the client assuming the inquiry is sent to more than two attorneys. In the end, an attorney who provides quality service for a fair price is likely to spend a significant amount of time responding to inquiries with no payoff as the prospective clients either choose not to move forward or retain a low cost provider. And in the off chance, such an attorney is actually retained, the attorney must balance the cost of the service against the amount of money earned through the representation.

Ask a number of attorneys and many will agree that the best clients tend to be those that are referred by other attorneys. Attorneys are not likely to refer bad clients to other attorneys for fear of damaging their own reputation in the legal community. Accordingly, referred clients are more likely to be clients that pay their bills and are easy to work with. Furthermore, attorney-referred clients are used to working and dealing with attorneys in contrast with prospective clients who use the above described internet based systems that have likely never dealt with an attorney.

Many of the aforementioned problems are not wholly unique to the legal profession. Rather, similar types of issues and problems can also occur among other professionals, such as doctors and accountants, in the operation and building of their respective practices. Furthermore, any vocation wherein a practitioner relies upon clients for his/her livelihood experiences issues that are conceptually similar to the issues experienced by a lawyer growing his or her practice.

### BRIEF DESCRIPTION OF THE DRAWINGS

FIG. 1 is a block diagram of a typical computer that can be utilized with embodiments of the present invention

FIG. 2 is a block diagram illustrating a software system comprising a plurality of modules according to one embodiment of the present invention.

FIG. 3 is a flow chart illustrating the process by which a prospective member of the referral service applies for and obtains membership according to one embodiment of the present invention.

FIG. 4 is a flow chart illustrating the process by which a member prepares and lists a referral on the referral system according to one embodiment of the present invention.

FIG. 5 is a flow chart illustrating the process by which a member views and bids on relevant referral listings according to one embodiment of the present invention.

FIG. 6 is a flow chart illustrating the feedback process of the referral system according to one embodiment of the present invention.

### DETAILED DESCRIPTION

Embodiments of the present invention comprise a network-based method and system for listing, bidding on, and sharing information concerning professional to professional referrals. One variation described in detailed herein specifically concerns attorney to attorney referrals.

In embodiments, only qualified professionals are able to become members of the referral service. Accordingly, only those referrals that the listing professionals consider worthy will be made available. Professionals, such as lawyers, typically offer referrals for current clients who need services that the listing professional does not provide. It follows that the clients associated with the referrals are generally more sophisticated with regard to the general nature of services offered by the particular type of professional and are less likely to just be shopping or fact finding. It is further appreciated that professionals, who value their reputation among colleagues, are not likely to offer referrals that they know or suspect are from clients who will waste the time of their colleagues. As an additional feature to help ensure the quality level of referrals offered, at least some embodiments provide for a ratings system wherein a winner of a referral has the opportunity to rank the referring professional based on the quality of the referral.

Embodiments of the invention utilize an auction format that permits professionals that are appropriately qualified to bid on particular referrals using credits or points. The professional who bids the most credits as of the end of an auction wins the referral and is either provided the contact information for the referring professional or the contact information for the prospective client directly as chosen by the listing professional. All or a predetermined portion of the credits are awarded to the referring professional so that he/she may use these credits to bid on other referrals. Accordingly, the referring professional is rewarded for listing a referral outside of his area of practice as he can then utilize the additional credits to bid and presumably win referrals that are within his area of expertise.

In embodiments, the credits have no monetary value and no usefulness outside of the referral service. Furthermore credits are non-transferable except in relation to a referral auction. Simply, the credits serve merely as a means of facilitating the referral of clients from one professional to another. Accordingly, the referral system is unlikely to run afoul of ethics rules governing the behavior of the professionals, such as lawyers, that in certain jurisdictions may prohibit the payment of a referral fee for a referral between professionals. As an additional feature of certain embodiments, the listing professional can require the payment of a specified monetary referral fee by the winning bidder.

To be a member of the referral service, a professional is typically charged a monthly fee although discounts can be made available if the professional pays for longer periods at one time. The monthly fee typically includes a predetermined number of credits that can be used to bid on referrals. Different tiers of membership can also be offered that vary the number of monthly credits received by the member. In variations, the member may also purchase additional credits as required. In at least one embodiment, the credits not used in any month carry forward thereby increasing the number of credits available to the professional member to bid assuming the credits are not previously used to obtain one or more referrals.

Other embodiments of the referral system are tailored to other sets of vocations wherein a practitioner in the vocation may not be considered generally to be a “professional”. Referral systems conceptually similar and having similar characteristics to the embodiments described above are contemplated wherein the members are practitioners of particular groups of related professions or vocations. For instance, in one such referral system, only members of trades relating to construction can join although the various members can practice various vocations, such as carpentry, dry walling, plumbing, electrical and flooring. The system would incentivize a member of one vocation to provide a referral listing on behalf of his/her customers that need reliable practitioners of another vocation.

In yet other embodiments, the referral systems described herein can be abstracted to larger more diverse groups of membership. For instance, in one variation, the system accepts as members any business owners. In another variation, groupings of professionals, such as accountants and lawyers, can join the service as members. In yet other even broader variations, there may not be a limitation of who can join and use the system. This last variation of the referral system serves as a somewhat universal marketplace wherein a practitioner of any suitable vocation can list referral requests for any of his/her clients to satisfy a need of that client that relates to products or services that are typically different from the products or services offered by the practitioner. Obviously, the particular listing practitioner may also list referrals for needs he/she may have personally.

### Terminology:

The terms and phrases as indicated in parenthesis (“ ”) in this section are intended to have the meaning ascribed to them in this Terminology section applied to them throughout this document including the claims unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

As applicable, the terms “about” or “generally” as used herein unless otherwise indicated means a margin of ±20%. Also, as applicable, the term “substantially” as used herein unless otherwise indicated means a margin of ±10%. It is to be appreciated that not all uses of the above terms are quantifiable such that the referenced ranges can be applied.

The term “Professional” as used herein typically refers to a person licensed to practice within a particular trade, although the term more generally applies to persons having a degree in or related to a particular profession that practice in that profession. The term “Trademan” as used herein typically refers to any person, male or female, that is practicing in a particular trade or in trades that are related. For instance the plumping trade and the electrical trade can be considered related in variations of the referral system since they share a common customer base.

The terms “credits” and “points” as used herein in reference to an auction medium are intended to have no monetary value or other use outside of the referral system. In most variations, the credits are non-exchangeable and are only useful for bidding on listings.

### An Exemplary Computer System

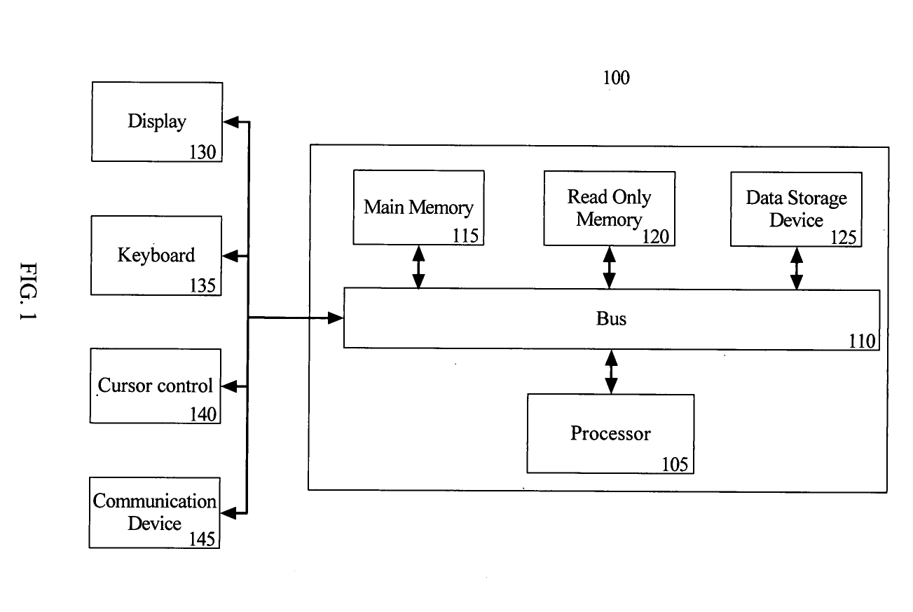

FIG. 1 illustrates an exemplary computer system 100 upon which embodiments of the invention may be implemented. The computer system can be utilized as a server upon which the referral service/system resides. Additionally, the computer system can be a client from which a professional accesses the referral service's web site. As contemplated herein the computer is typically coupled with a network, such as the Internet, through which the referral service computer and a client computer can transfer and access information through any suitable means including but not limited to web sites, email, instant messaging and wireless communications.

The computer system typically comprises a bus 110 or other communication means for communicating information, and a processing means, such as a processor 105, coupled with the bus for processing information. The typical computer system further comprises a random access memory (RAM) or other dynamically-generated storage device 115 (referred to as main memory), coupled to the bus for storing information and instructions to be executed on by the processor. The main memory 115 may also be used for storing temporary variables or other intermediate information during execution of instructions by the processor. The computer system also typically comprises read only memory (ROM) 120 and/or another static storage device coupled to the bus 110 for storing static information and instructions for the processor.

A data storage device 125, such as a magnetic disk, an optical disk and its corresponding drive, or a flash memory storage device may also be coupled to the computer system 200 for storing information and instructions. The computer system can also be coupled via the bus 110 to a display device 130, such as a cathode ray tube (CRT) or Liquid Crystal Display (LCD), for displaying information to an end user. Typically, an alphanumeric input device (keyboard) 135, including alphanumeric and other keys, may be coupled to the bus for communicating information and/or command selections to the processor 105. Another common type of user input device is cursor control device 140, such as a mouse, a trackball, a trackpad or cursor direction keys for communicating direction information and command selections to the processor and for controlling cursor movement on the display.

A communication device 145 can also coupled to the bus 110. The communication device may include a modem, a network interface card, or other well-known interface devices, such as those used for coupling to Ethernet, token ring, or other types of physical attachment for purposes of providing a communication link to support a local or wide area network, for example. The communications device may also be a wireless device for coupling to a wireless network.

It is appreciated that a lesser or more equipped computer system than the example described above may be desirable for certain implementations. Therefore, the configuration of computer system 100 will vary from implementation to implementation depending upon numerous factors, such as its intended use, price constraints, performance requirements, technological improvements, and/or other circumstances.

It should be noted that while embodiments of the referral service system and method described herein may be performed and used with a computer similar to the one described herein, other embodiments and variations can be used with other information devices, such as but not limited to PDAs, Internet Appliances, and wired and wireless telephonic communications systems. Therefore, nothing disclosed herein concerning the configuration of the illustrated computer should be construed as limiting the present invention to a particular embodiment wherein the recited operations are performed by a specific combination of hardware components.

### An Embodiment of a Professional Referral Service System

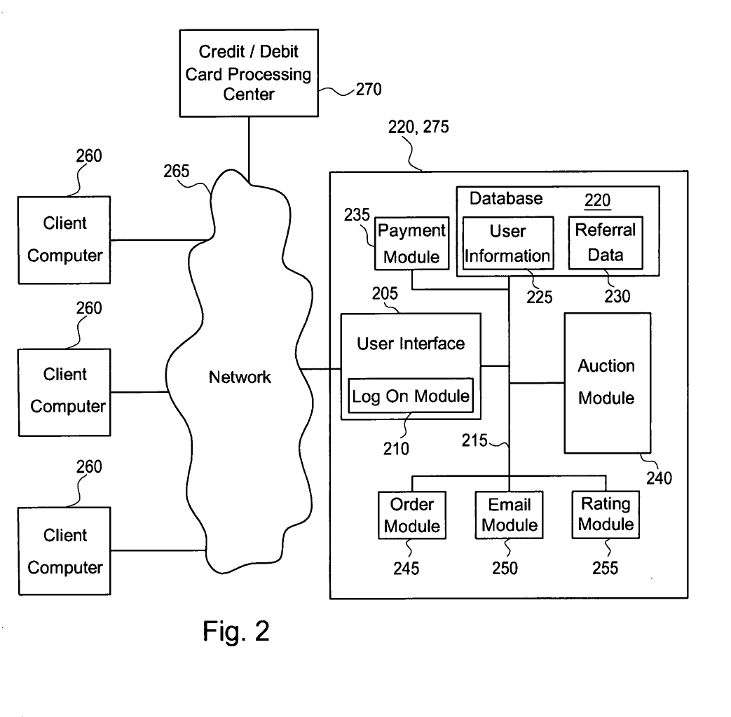

In certain embodiments, the referral system comprises a program typically encoded in software running on a computer 100 similar to the type described above. A prototypical referral system program 200 comprising a plurality of software modules is illustrated in FIG. 2. In some variations, the software modules are all resident on a single server computer 275 that is coupled to a network 265, such as but not limited to the Internet. In other variations, the various software modules can be distributed between a plurality of computers that are networked together. As illustrated herein, a plurality of client computers 260, such as computers operated by professionals can be coupled to the network with the ability to functionally access certain information stored within the referral system. Additionally, the referral system can be configured to interface with other computers coupled to the network, such as but not limited to a credit/debit card processing center 270.

While the embodiment illustrated herein is described primarily in reference to a professional to professional referral system and more specifically to an attorney to attorney referral system, substantially similar programs can be used for other embodiments of the referral system (as described in this document) with any necessary modifications as would be obvious to one of ordinary skill in the art given the benefit of this disclosure.

At the front end, a user interface 205, which in certain variations comprises one or more web pages, is provided through which a professional may access the referral system over the associated network 265. Since embodiments of the system are intended to be used only by like professionals, such as attorneys, only limited information will be available to the non-member public. Further, a visitor may be able to access additional public pages providing one or more of the following: a description of the service and how it works, membership requirements, membership pricing, relevant news, and frequently asked questions. Also, typically available on the first page, or by way of another page for which a link is provided on the first page, is a login prompt that provides a text box for a member to enter one or both his/her username and password.

The login prompt is associated with a log on module 210 that looks up the username in a database 220 and compares the entered password with the password stored in the database. If the passwords match, the user is typically directed to his/her homepage within the system that includes listings and/or links for (i) the referrals currently available, (ii) the referrals he/she has bid on and their respective status, (iii) referrals he/she has won, (iv) referrals he/she is listing, and (v) the number of credits in his/her account. Additional direct or indirect links can be provided to other pages including but not limited to: (a) ordering pages from which a member can order more credits or change the status of his/her membership; (b) preference pages wherein the member can provide information about him or herself and the manner in which he/she interacts with the system; (c) rating pages wherein the member can provide ratings of members that he/she has won a referral; (d) listings pages where he/she can provide a referral listing to be bid on by other members; and (e) auction pages related to specific referral listing in which he/she is eligible to bid.

The various pages are operationally coupled as applicable to the various other software modules by way of a suitable interface 215 or interfaces. For instance, where the referral system comprises a single program running on a single computer 275, the modules may be distinct routines or objects that are called or invoked by other objects or routines as required. In other variations wherein the modules are located on separate computers or wherein one or more modules is a standalone executable file on a single computer, the interface(s) 215 may comprise either or both of a bus and/or a network connection.

Some of the modules provided in the referral system include the aforementioned database 220 that includes member information 225 and referral listing data 230. The database is queried as necessary by the other modules.

Another module is a payment module 235 that is adapted to (i) charge a member his/her fees on a suitable periodic basis, such as monthly or annually, and (ii) charge the member for additional credit purchases. The payment module is ideally able to access a credit/debit card processing center 270 via the network either directly or through the a suitable interface to charge a member's credit or debit card and/or debit a member's bank account as authorized by the member. Often the payment module will be utilized in conjunction with or even integrated with an order module 245. The order module is adapted to provide a member or prospective member with information concerning the costs of membership and credits as well as facilitate the billing of those costs often by way of the aforementioned payment module.

An auction module 240 is typically provided to coordinate execute tasks related to a referral listing auction. Typical functions performed by the auction module include but are not limited to: (a) tracking the amount of credit bid on each listing and the identity of the bidder; (b) tracking the time left in an auction; (c) debiting the listing professional the proper portion of the winning number of credits bid on a concluded referral auction; (d) updating the database with appropriate member information as it relates to one or more referral listing auctions; and (e) sending notification to various members often in concert with the email module 250 concerning the status of an auction.

The email module 250 is adapted to send email messages to members through the associated network as directed by one or more other modules. For instance, a member can be notified by email that a new referral listing auction has been initiated that matches his/her practice areas and associated geographic region. The email module can send notification to a member that his/her credit card has been billed as directed by one or both the order and payment modules 245 & 235. The email module can send a member notification that he/she has won a referral auction or that he/she has been outbid. In variations, the email module can also send a notification by a ratings module 255 to a listing member that feedback has been entered for the member based on a listing he/she has provided.

In variations, the email module can also receive email from members, and based on the information provided update user or referral information. For instance, in one variation, a member can be notified that he/she has been outbid and the member is able to reply to the email message with a new higher bid. The email module upon receiving the reply sends the new bid information to the auction module 240 for processing.

A aforementioned ratings (or feedback) module 255 can be provided to solicit, track and tabulate feedback ratings provided by the various members for other members relative to concluded referral auctions. In one variation, the ratings module can, in conjunction with the email module 250, send a request for feedback to a winning member concerning the listing member of a concluded auction. Upon receiving the feedback, the module updates the user information database as necessary. Additionally, the module can have an email sent to the listing member indicating the content of the feedback and giving the listing member the opportunity to respond thereto. In other variations, a ratings scheme is employed as would be obvious to one of ordinary skill in the art given the benefit of this disclosure. The rating module tabulates and updates the ratings of the various members periodically or as necessary.

It is to be appreciated that the various modules provided in FIG. 2 and their organization are merely exemplary and can vary substantially depending on how the referral system is configured and constructed. For instance, modules can be stand alone applications or merely components of a larger application. The various modules can be separate and distinct from each other as illustrated or they can be integrated with each other in any reasonable and suitable configuration. Modules can be broken up into suitable sub-modules. Further, additional modules not specifically described above or illustrated can be provided. In short, the organization of the software is not intended to be limited to a particular manner of organization so long as it can execute the functionality described generally in this specification and more specifically, as applicable, in the appended claims.

### Method of Operation of Referral System According to an Embodiment of the Referral System

Prior to being able to use the referral system to either bid on referrals or list referrals a professional typically must become a member of the system. In some variations, membership is available to only those persons that meet certain threshold requirements such that all or a substantial portion of all members in a particular embodiment of the system are peers. For instance, one variation of the system can be provided for the use of attorneys to obtain and provide referrals to other attorneys. People seeking legal representation are typically not permitted to become members of the system. The strong presumption is that referrals offered from other attorneys will tend to be of higher quality than leads generated as a result of inquiries coming directly from a potential client.

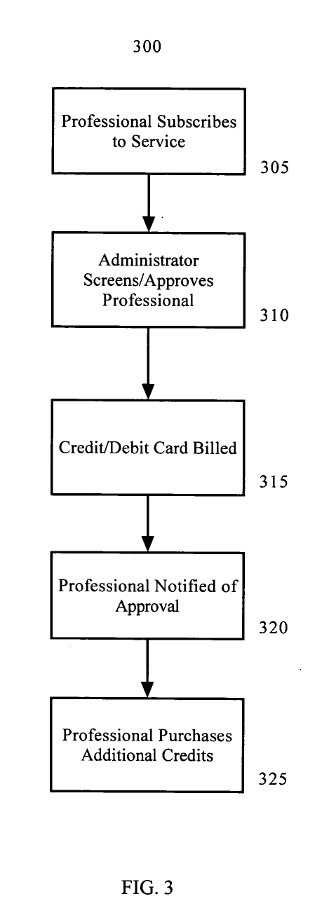

FIGS. 3-6 provide flow charts illustrating the operation of a variation of the referral system. The accompanying description relates primarily to attorneys although it is understood that other variations can be implemented that pertain to other types of professionals, such as but not limited to physicians and accountants.

It is also appreciated that a referral system embodiment can also be aimed at other vocations that are not typically considered to be professional vocations. For instance, a referral system can be provided that is only open to people or companies involved in the home remodeling or renovation trades. As an example, a flooring tradesman might be asked by a customer to recommend a good countertop installer. The flooring tradesman can provide a listing on the remodeling trade referral system which various countertop installers can bid to receive the job. As explained in more detail below, the flooring tradesman may request a referral fee in addition to a portion of the credits awarded at the conclusion of the auction. In addition to providing a mechanism for obtaining jobs, this type of referral system can be utilized by a tradesman, especially one just starting out in a trade, to more quickly develop contacts related to his/her profession.

Another referral system embodiment can have an even broader group of eligible members including anyone practicing in a vocation that benefit from referrals (e.g a hairdresser list a referral to find an accountant for his/her customer).

Referring to FIG. 3, an attorney or other professional desiring to join a referral system must first subscribe or apply to become a member as indicated in block 305. Typically, the process involves entering the network address, typically a URL, into a computer attached to a relevant network, such as the Internet. The front page is typically supplied by the referral system user interface 205 and displayed on the attorney's computer. A direct or indirect link(s) can be provided that directs the attorney to another page or a series of pages supplied by the system whereat the attorney can fill in an online application and submit the application to the system for approval.

Some of the information collected can include: (i) an applicant's name; (ii) his/her firm affiliation as applicable; (iii) the jurisdictions he/she is registered to practice in and his/her bar numbers; (iv) the attorney's areas of practice (one embodiment permits an attorney to choose up to five); (v) contact information such as email address, phone numbers and physical address; (vi) the applicant's preferences concerning his/her interaction with the referral system; (vii) a user name and password; and (viii) in some variations, references. Payment information, such as a credit card number, is also provided along with the type of membership the attorney desires.

In variations, a number of membership options can be provided. The attorney may be able to choose a month to month membership with no long term commitments. In other variations, he/she may receive a discount if a longer period of membership is chosen. A certain number of credits are typically provided as part of the membership. The credits can be provided all at once upon joining or an allotment can be provided on a periodic basis, such as monthly. There may be differing levels of membership wherein a premium level receives a greater allotment of credits than a standard level.

The application information is then processed for approval or rejection of the applicant as indicated in block 310. In at least one variation, the applicant's information or a portion thereof is forwarded to a system administrator. The administrator manually verifies that the applicant meets the criteria for membership. For instance, an attorney must be registered to practice in any geographic area in which he/she desires to view and bid on referral listings. The administrator may inquire as to the applicant's standing with the bars listed by the applicant. In other embodiments for other types of professionals, the administrator will check with the relevant governing organization. For other types of professions and trades wherein there are no licensing or regulatory boards, the administrator may check the applicant's status with various consumer organizations, such as but not limited to the Better Business Bureau (BBB).

In variations, the qualifications of the applicant are checked automatically by the referral system software and the computer/server on which the software is running. The server would query an online database of the relevant bar(s) to determine whether the applicant is a member of the bar(s). In this variation, the verification of the applicant can be contemporaneous with the processing of the application, and accordingly, the applicant can be approved within seconds or minutes of submitting the application.

Referring to block 315, once the applicant is approved for membership his/her credit or debit card is typically charged for the appropriate and agreed upon amount. In variations, the applicant/new member can provide his/her bank information to facilitate automatic withdrawal of the agreed upon finds on the relevant periodic basis. In yet other variations, the applicant may have the option to mail in a check or cash as payment for manual processing, although payment by this means may delay activation of the membership.

As indicated in block 320 the attorney is notified that his/her membership has been approved. Where the screening/approval process of block 310 is performed manually by an administrator, the notification can occur by any suitable means but is typically through an email to the address provided by the applicant. Where the screening process is automated, the notification may be contemporaneous with the submission of the application and can be in the form of a web page provided by the referral system through the user interface indicating approval. After approval, the new member can access and review active referrals in his/her geographic region that pertain to his chosen areas of practice and/or he/she can provide referral listings to be bid upon by other members.

As described above and indicated in block 325, the new member will typically be provided with a certain number of credits with the activation of the membership. However, the member can typically purchase additional credits at any time by accessing an order page via the network and processing an order for the desired number of credits.

Additionally in some variations, the member can modify his/her listing and preferences as desired by accessing information stored in the system. Of course, when changing certain information such as that relating to bar memberships and the member's geographic scope of practice, the changes may require administrator approval before the requested changes are applied to the member. In some variations, the member maybe able to add more practice areas above and beyond the normal maximum (five in one embodiment) for the payment of additional fees that can be one time or periodic.

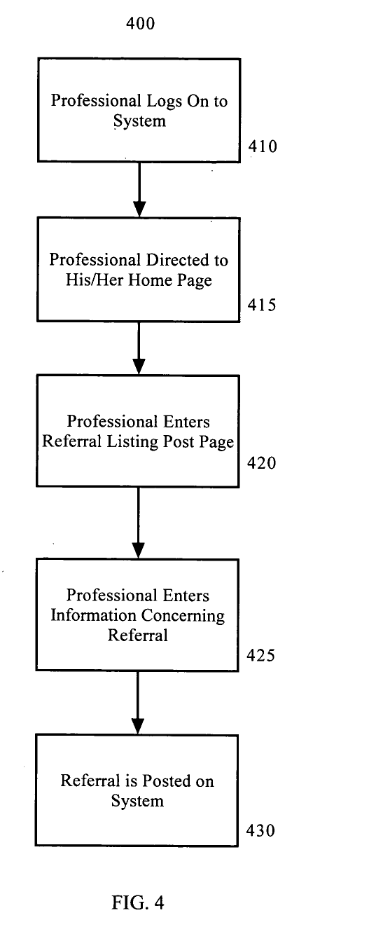

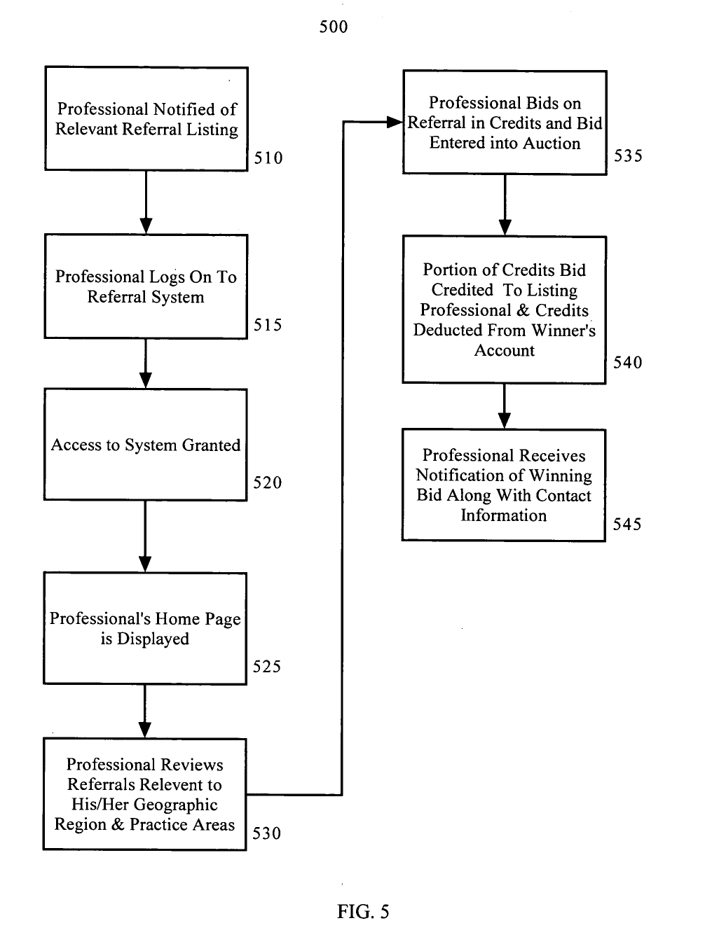

The two primary activities undertaken by a member of the referral system aside for account and preference maintenance are the listing of referrals; and the bidding on referrals as are illustrated in FIGS. 4 and 5 respectively.

Referring specifically to FIG. 4, the process of listing a referral is illustrated. First, as indicated in block 410, the attorney member logs onto the referral system by entering his/her user name and password. The system verifies that the password is the correct password associated with the username by accessing the user information associated with the name in the system database. Provided the password is correct, the member is directed to his/her home (or start) page as indicated in block 415.

A member's home page within the referral system can include (i) a listing of all referrals the attorney is bidding on, (ii) a list of all referrals being listed by the attorney, (iii) the number of credits held by the attorney, (iv) any messages that have been sent to the member from either the administrator or other members, (v) a list of historical referrals, namely those the member has listed or has won within a predetermined period of time, and (vi) possibly a list of all referrals for which the attorney is eligible to bid on providing the number is not too large. The information displayed on the home page can also include the attorney's membership status, and a listing of his/her eligible geographic region and practice areas. Additionally, links are provided to pages whereat the member can (a) provide a referral listing, (b) view relevant live listings, (c) contact the administrator, (e) log out, (f) view information concerning the operation of the referral system, such as a FAQ page, and (g) log out of the system.

The link to the referral listing page is selected by the member and the referral system displays a front page of the referral listing template as indicated in box 420. In some variations, the referral listing template can comprise a single page, but in others, the template can be distributed over several pages. A typical template is described herein with the understanding that numerous variations as would be obvious to one or ordinary skill in the art are possible.

The template is often divided into a series of sections with each section relating to a particular type of information required relative to a listing. The listing attorney enters the referral listing information as indicated in block 425. Some of the requested information can be optional and other information may be required to activate a listing. The member is provided a section to title the listing and provide the city and state in which the prospective client is located or where the referral is to be preformed. The referral system uses the city and state information to determine the geographic area in which the listing will be available for viewing to other members.

In a next section, the member enters in one or more categories to which the referral pertains, such as patent law, personal injury law and contract law. In certain variations, the category selection section comprises one or more drop down menus consisting of a set of predetermined categories that match the categories relating to the areas of practice chosen by members when they set up their membership account. Operationally, members are typically alerted to referral listings that are both within at least one of their areas of practice and relate to a matter occurring within their approved geographic area. Of course, in variations criteria determining which and what referral listings a member is alerted to or can view can vary substantially as would be obvious to one of ordinary skill in the art to which the invention pertains given the benefit of this disclosure.

In another section in some variations, the listing member can specify a reserve number of credits below which the winning bidder will not be awarded the referral. In some variations, the ability to provide an initial minimum bid amount may also be provided.

In yet another section in some variations, the member can indicate whether a set monetary referral fee is required on top of the winning bid in credits. Further, a text dialog box can be provided that permits the listing member to list any terms related to the payment of the referral fee. For instance in some instances, the fee may be due before the referral information is provided to the winning member. In other instances, the fee may not be earned by the listing member until the work is actually performed by the winning attorney.

Of significant note, several jurisdictions, such as Colorado, do not permit the exchange of referral fees among attorneys and as such the referral fee section may not be available to lawyers located in the relevant jurisdiction. In other variations, the referral fee section may be available in all jurisdictions with the understanding that a member should not request a referral fee if he/she is not permitted to do so.

The next section permits the listing member to provide information about the referral listing itself. The information will typically include: (i) the name of the client being referred; (ii) the address of the client and contact information; and (iii) the specific details concerning the particular matter. In variations, a check box can also be provided wherein the listing agent permits the client name and contact information to be displayed to the winning member. If the box is unchecked, only the contact information for the attorney will be provided to the winning member at the conclusion of a referral listing auction; thereby keeping the name and contact information for the client confidential.

It is to be appreciated the form and format of the referral listing sections and templates can vary significantly and substantially depending on the design of a particular referral system and the profession(s) to which it relates. Once the referral listing is fully entered by the listing attorney and reviewed by the listing attorney for correctness, the referral is posted as indicated in block 430.

Referring specifically to FIG. 5, an attorney member will periodically be notified when new listings relating to his/her practice areas within his/her geographic area of practice as indicated in block 510. Typically, notification can be by way of an email although in variations other notification means can be utilized including but not limited to a telephonic message, an instant message, a letter or postcard, and a voice mail. In other variations, the member notification can be omitted either completely or by member preference. In such a variation, the member would log on to the referral system site to access the listings pertinent to him/her.

Whether or not the member is notified of a listing via email or other means, the user can be required to logon and gain access to the system as indicated in blocks 515 & 520 in order to view the complete listing and/or bid on the listing.

In some variations, however, the email communication concerning a listing can be complete and can include a box in to which a member can enter a bid in credits to be posted relative to the listing without ever having to access the system directly through a browser or other suitable application. To bid directly by way of email, the member may also be required to provide his or her password along with the bid amount to hinder unauthorized bidding by others who may have access to the member's email.

Typically, after logging in, the member is directed to his/her home page as has been previously described supra and as indicated in block 525. A list is typically provided on the home page of the most recent referrals of which the member is eligible to bid.

By clicking on a hyperlink and/or button icon associated with a referral listing, the member is displayed a page or pages providing the specifics concerning the listing. In some variations, the name of the listing attorney is not provided with the specifics; however, in other variations it can be. Further, the choice concerning whether the listing attorney's name and/or contact information is provided may be the choice of the attorney as indicated globally in the listing attorney's preferences or as chosen when preparing the specific listing. In other variations, however, whether or not the listing attorney is not identified, his or her system feedback rating is provided. Additionally, a link or box may be provided wherein the viewing member can ask the listing attorney questions about the referral. The questions and associated answers may or may not be displayed with the listing to be viewed by any member who views the complete listing.

An attorney member actively seeking to bid on one or more referral listings will typically logon and visit his/her referral system home page on a periodic basis to review the specifics concerning active listings he/she is qualified to bid on and identify those that are attractive opportunities as indicated in block 530. The member can also view the status of those referral listings in which he is actively bidding and as necessary increase the number of credits he/she is bidding to regain his/her status as the top bidder.

As indicated in block 535, the member can either enter the number of credits he/she desires to bid on a listing directly into a box provided on the listing page(s) and submit the bid. Alternatively, a bid link/button can be provided that brings the member to a specific bidding page(s) wherein he/she enters the number of credits he/she desires to bid, and then submits the bid.

The listing auction can be implemented in any suitable fashion using any one or multiple variations of readily known online auction protocols as would be obvious to one of ordinary skill in the art to which the invention pertains. For instance a system similar to that utilized on Ebay.com can be utilized wherein the member allocates a reserve number of credits and the system bids the credits as necessary to maintain the member's status as the high bidder until his/her allocation is exceeded. In some variations, the auction might end promptly at a predetermined closing time and date, but in other variations, the bidding can be extended past the close time a certain amount of time after the last bid (i.e. 5 minutes).

Further in some variations, the system via the email module or other communications functionality can notify a member that he/she has been out bid and invite the member to enter a new higher bid.

After the auction closes, the winning attorney member is notified via email or other suitable means that he/she has won the auction as indicated in block 540. Typically, either or both the listing member's contact information and the prospective referred client's listing information will be provided to the winning member. In some variations, the contact information is provided by way of a link that appears on the member's home page relative to the portion listing the referrals the member has won. In other variations, the member can also be directly contacted by email or some other suitable communications means.

Generally contemporaneously with the notification of the winning member as indicated in block 545, the number of credits bid by the winning member are subtracted from his/her account and all or a portion of the credits are credited to the listing members account for use by the listing member to bid on referrals that he/she is interested. In at least one variation, half of the credits bid are transferred to the listing member and the other half of the credits are retained by the system. The apportioning of credits can, however, vary substantially.

In certain variations, the referral system's involvement with the referral ends at the conclusion of the auction and the sharing of contact information between the listing and winning members except for the collecting and publishing of feedback related to the referral. In at least one variation, the referral system administrators make no representations or warranties concerning the quality of a referral related to a referral listing. Further, the administrators do not guarantee that the listing attorney will provide the referral listed. The administrators are not obligated or required to return or adjust any credits as a result of a less than satisfactory referral experience by either or both the listing member and the winning member. The system administrators reserve the right and option to police the activities of its members especially when a member is abusing or misusing the system.

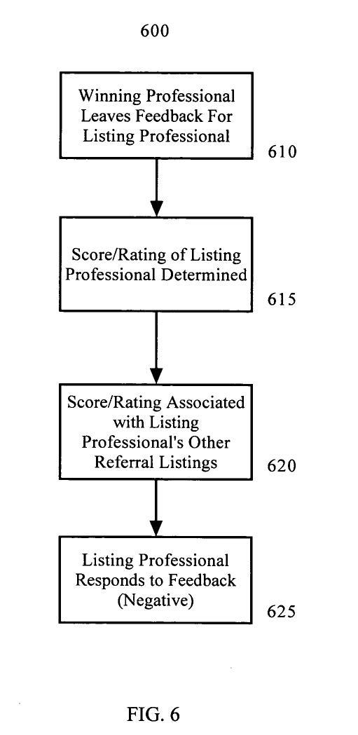

Referring to FIG. 6, the referral system is primarily self-policing through the use a referral feedback system. Typically after winning a referral, a member is notified that he/she may provide feedback concerning the specific referral. In some variations, the link to a feedback page will be provided on the page that provides the contact information for the listing member. In other variations, the winning member can be prompted to provide feedback on his/her home page or by email. It is anticipated that the winning member may not be able to provide meaningful feed back for a significant period of time after the referral is won as the quality of the referral may only be ascertained after the winning member is retained by the client associated with the referral and has performed the work. Accordingly, a significant period of time can be provided to the winning member to respond to provide feedback, although the system may limit the time that a winning member has to provide feedback.

When the winning member has formed an opinion concerning the quality of the referral, he leaves feedback for the listing attorney as indicated in block 610. The winning attorney can be permitted to provide unstructured feedback comments in a text box that is provided on a feedback page or other suitable page within the system; however, the length of the comments may be limited to a predetermined number of characters. Free form comments may be reviewed by a system administrator for approval to ensure the comments are not obviously slanderous, profane or identify the listing member to which the comment pertains. In some variations, a member may select a predetermined rating for the feedback from a drop down box, radio buttons or other suitable means in addition to or instead of the freeform text box. In yet other variations, the member can choose from a set of predetermined written phrases or sentences that describe the referral. The actual form and content of the feedback can vary significantly as would be obvious to one of ordinary skill in the art given the benefit of this disclosure.

As indicated in block 615, in some variations of the referral system, a feedback score is calculated for the listing member based on all feedback associated with the member concerning his/her referral listings. The score may be as simple as the percentage of positive feedback relative to all feedback offered or the score may be the result of a more complex set of statistical calculations as would be obvious to one of ordinary skill given the benefit of this disclosure. Other variations, such as those wherein the feedback is primarily freeform text, may not generate an overall feedback rating.

After the score is tabulated, the feedback score and the feedback comments are typically associated with the listing member as indicated in block 620. The rating and the comments are viewable by other members relative to new referral listings. Accordingly, a member interested in bidding on a particular referral can review the success of referrals listed in the past by the member and determine whether and how much to bid on a particular listing. Presumably, those members who list a referral and refuse to honor the referral by providing the necessary information to the winning member will receive poor feedback and thereby reduce the perceived value of future listings.

In instances where a listing member receives negative feedback, he will typically be afforded the opportunity to post a response to the negative feedback as indicated in block 625. In some variations, the listing member will be given the opportunity to respond to positive feedback as well, although the value of such feedback might be minimal since in most variations there is no mechanism for members to view the feed back of members who are bidding on or have won a listing. However, variations are contemplated wherein a listing member may be able to see feedback associated with a person bidding on his/her listing and can have the ability to restrict the auction to only those members that have a predetermined level of positive feedback.

### Other Embodiments and Variations

The various embodiments and variations thereof illustrated in the accompanying Figures and/or described above are merely exemplary and are not meant to limit the scope of the invention. It is to be appreciated that numerous variations of the invention have been contemplated as would be obvious to one of ordinary skill in the art with the benefit of this disclosure.

For instance, the actual graphical design of the web pages or other interface that facilitates interaction with the system can vary significantly and substantially without affecting the methodology and operating characteristics of the various embodiments. As also mentioned above, the actual organization of the software associated with the referral system can vary significantly depending on the type of server/computer that the system is hosted, the language in which the software was coded and complied, and the specific system variations described herein. Additionally, as also mentioned above, the referral system is not limited to use by professionals, such as attorneys, doctors and accountants, but can be applied to other vocations and industries.

I claim:

1. A method of referring clients between professionals in a predetermined profession comprising:
accepting as members only professionals within a particular predetermined profession;
accepting a listing provided by a first member of the members concerning a need by an entity for professional services in the predetermined profession wherein the first member is not the entity; and
posting the listing for viewing by qualified members of the members.

2. The method of claim 1, wherein the predetermined profession is one of: the legal profession; the medical profession; and the accounting profession.

3. The method of claim 1, further comprising:
receiving an request for membership by an applicant; and
verifying the applicant is a professional with the predetermined profession.

4. The method of claim 1, wherein an applicant for membership indicates at least of: (i) one or more specialties within the predetermined profession; and (ii) the applicant's geographic area of practice, and wherein qualified members include members who practice a specialty related to the need of the entity.

5. The method of claim 1, further comprising:
conducting an auction for the listing, providing contact information for one or both the first member and the entity to a second member after a conclusion of the auction, the second member being a high bidder in the auction.

6. The method of claim 5, further comprising:
providing each member with a plurality of non-monetary credits; and
wherein auction accepts credits as a bidding medium.

7. The method of claim 6, further comprising:
awarding a portion of the credits bid by the second member to the first member.

8. The method of claim 1, wherein a monetary referral fee is associated with the listing.

9. The method of claim 3, wherein said verifying comprises an administrator contacting a bar listed by an attorney applicant to verify membership in the bar.

10. A method of operating an online legal referral service, the method comprising:
accepting only attorneys as members;
providing a plurality of online referral listings provided by a plurality of members, the referral listings concerning a prospective client having a need for legal services in a particular practice area; and
permitting members to view the referral listings.

11. The method of claim 10, wherein the plurality of online referral listings are provided in an auction format, and further comprising auctioning each referral listing of the plurality of referral listings to a highest bidding member.

12. The method of claim 11, further comprising providing members with a plurality of non-monetary credits, and wherein the credits are the medium bid in an auction.

13. The method of claim 12, wherein the credits only have value within the referral service and are non-transferable except through an auction.

14. The method of claim 13, wherein (i) a name and contact information of each member providing an online referral listing is not provided during an associated auction, and further comprising providing a name and contact information for each member providing an online referral listing to a highest bidding member at the conclusion of an associated auction.

15. A method of operating a vocation to vocation referral service, the method comprising:
accepting a plurality of members;
receiving a first listing from a first member, the first listing including information concerning a need for products or services of an entity acquainted with the first member;
posting the first listing;
restricting viewing of the first listing to other members;
conducting an auction for the listing wherein non-monetary credits are used as a bidding medium, the only use of the credits being for bidding on listings posted by the referral service; and
sending contact information relative to the first member to a second member at a conclusion of the auction, the second member being the high bidder in the auction.

16. The method of claim 15, further comprises Deducting a first amount of credits from the second member and transferring at least a portion of the first amount to the first member.

17. The method of claim 15, further comprising charging each member a membership fee on a periodic basis.

18. The method of claim 17, further comprising providing each member a predetermined quantity of credits on a periodic basis.

19. The method of claim 15, wherein the plurality of members consist of attorneys

20. The method of claim 19, further comprising restricting viewing of the first listing to members practicing within an area of practice associated with the first listing and members practicing with a geographic region associated with the first listing.
